(19) United States
(12) Patent Application Publication
(10) Pub. No.: US 2026/0294170 A1
(43) Pub. Date: Oct. 1, 2026

(54) DEEP FRYER AND COOKING EQUIPMENT

(71) Applicant: Haohong Electric Technology (Hubei) Co., Ltd., Huanggang (CN)

(72) Inventor: Min WANG, Huanggang (CN)

(73) Assignee: Haohong Electric Technology (Hubei) Co., Ltd., Huanggang (CN)

(21) Appl. No.: 19/240,369

(22) Filed: Jun. 17, 2025

(30) Foreign Application Priority Data
Mar. 31, 2025 (CN) 202520594155.6

(51) Int. Cl. A47J 37/12

(52) U.S. Cl. CPC A47J 37/1295; A47J 37/1219

(57) ABSTRACT

A deep fryer includes a pot body, a frying basket, a handle and an adjustment assembly. The pot body is provided in a furnace body; the frying basket is provided in the pot body, and the handle is detachably connected to the frying basket. The adjustment assembly includes a slide rail, a slide rod and a locking member. The slide rail is provided at the outer wall surface of the pot body; the slide rod is slidably provided at the slide rail along a first direction and is configured to abut against the inner wall of the furnace body, and the locking member is provided at the slide rail and is configured to lock the position of the slide rod.

### CROSS-REFERENCE TO RELATED APPLICATIONS

The present application claims priority to Chinese Patent Application No. 202520594155.6, filed on Mar. 31, 2025, the entire contents of which are incorporated herein by reference.

### TECHNICAL FIELD

The present application relates to the technical field of food processing equipment, in particular to a deep fryer and a cooking equipment.

### BACKGROUND

A deep fryer is a cooking equipment specially used for deep frying food, which is widely used in the catering industry, food processing enterprises and home kitchens. The cooking equipment is mainly composed of a furnace body and a deep fryer. The furnace body plays the role of supporting, protecting and providing heat source, and the deep fryer is used to hold oil and fry food. However, the traditional deep fryer can only be adapted to a single furnace body, which has the technical problem of poor compatibility.

Therefore, it is necessary to provide a new deep fryer and cooking equipment to solve the above-mentioned technical problems.

### SUMMARY

The main purpose of the present application is to provide a deep fryer and cooking equipment, aiming to solve the technical problem of poor compatibility of the deep fryer.

In order to achieve the above-mentioned purpose, the present application provides a deep fryer, which is applied to a cooking equipment. The cooking equipment includes a furnace body, and the deep fryer includes a pot body provided in the furnace body, a frying basket provided in the pot body, a handle detachably connected to the frying basket, and an adjustment assembly including a slide rail, a slide rod and a locking member.

The slide rail is provided at an outer wall surface of the pot body, the slide rod is slidably provided at the slide rail along a first direction and is configured to abut against an inner wall of the furnace body, and the locking member is provided at the slide rail and is configured to lock a position of the slide rod.

In an embodiment, the slide rail is configured to extend along the first direction, the slide rail is provided with a guide hole extending along the first direction, and the slide rod is slidably provided in the guide hole.

In an embodiment, the locking member includes a locking screw, and the locking screw is configured to pass through the slide rail and abut against the slide rod to lock the position of the slide rod.

In an embodiment, the locking member includes a locking block, and the slide rod is provided with a plurality of locking holes spaced apart along the first direction; and the locking block is configured to pass through the slide rail and is inserted into any one of the locking holes to lock the position of the slide rod.

In an embodiment, a clamping block is provided at an outer wall surface of the frying basket, the handle includes a clamping portion, and the clamping portion is clamped with the clamping block.

In an embodiment, the clamping block is provided with an accommodation cavity, an opening and two clamping holes provided opposite to each other, and the opening is communicated with the accommodation cavity. The two clamping holes are both communicated with the accommodation cavity and are adjacent to the opening.

The clamping portion includes a first clamping rod and a second clamping rod provided at an interval, the first clamping rod is provided with a first clamp, and the second clamping rod is provided with a second clamp. The first clamping rod and the second clamping rod are configured to pass through the opening and are accommodated in the accommodation cavity; and the first clamp is inserted into one clamping hole, and the second clamp is inserted into the other clamping hole.

In an embodiment, the first clamp is a first bent latch rod, and the first bent latch rod is bent from the first clamping rod to a direction away from the second clamping rod; and the second clamp is a second bent latch rod, and the second bent latch rod is bent from the second clamping rod to a direction away from the first clamping rod.

In an embodiment, the handle further includes a grip block, a first link rod, a second link rod and a locking ring. The first link rod and the second link rod are provided apart at the grip block, the first link rod is connected to the first clamping rod, and the second link rod is connected to the second clamping rod. The locking ring is slidably provided at the first link rod and the second link rod, and a distance between the first link rod and the second link rod gradually decreases along a direction from the frying basket to the handle. The locking ring is configured to slide to an end of the first link rod and the second link rod away from the grip block to make the first link rod and the second link rod close to each other.

In an embodiment, a hook is provided at an end of the frying basket away from the handle, the furnace body is provided with a hanger, and the hook is hung on the hanger or a side plate of the pot body.

In addition, the present application further provides a cooking equipment, which includes a furnace body provided with a heating unit, and two deep fryers as above-mentioned. Two deep fryers are provided in the furnace body at an interval and are provided above the heating unit.

The technical solution of the present application can improve the compatibility of the deep fryer by arranging an adjustment assembly including a slide rail, a slide rod and a locking member on the pot body, so that the deep fryer can be placed in and fixed in a variety of cooking equipment of different sizes. In this embodiment, the pot body is used to hold oil, the frying basket is used to hold food, and the handle can be held by the user so that the user can place the frying basket in the pot body. The adjustment assembly includes a slide rail, a slide rod and a locking member. The slide rail is installed on the outer wall surface of the pot body. The slide rod is slidably installed on the slide rail and can abut against the inner wall of the furnace body to fix the position of the pot body. The locking member is used to lock the position of the slide rod to ensure that the position of the slide rod is stable, thereby fixing the pot body and ensuring the stability of the position of the pot body when it is placed in the furnace body. The adjustment assembly can improve the compatibility of the deep fryer, so that the deep fryer can be placed in and fixed in a variety of furnace bodies of different sizes. Specifically, when the deep fryer is placed in furnace bodies of different sizes, the user can adjust the extension length of the slide rod so that the slide rod abuts against the inner wall of the furnace body, and use the locking member to lock the position of the slide rod, so that the deep fryer can be firmly fixed in the furnace body, ensuring that the position of the deep fryer is stable when placed in furnace bodies of different sizes. In addition, the handle of the deep fryer is detachably connected to the frying basket, so that the user can remove the handle from the frying basket when frying food, and cover the furnace cover to fry food, so as to prevent oil from splashing outside the furnace body and endangering the safety of the user. The deep fryer is applied to the technical field of food processing equipment.

### BRIEF DESCRIPTION OF THE DRAWINGS

In order to more clearly illustrate the embodiments of the present application or the technical solutions in the related art, the drawings required for use in the description of the embodiments or the related art will be briefly introduced below. Obviously, the drawings described below are only some embodiments of the present application. For persons skilled in the art, other drawings can be obtained based on the structures shown in these drawings without paying creative efforts.

FIG. 1 is a structural diagram of a deep fryer according to an embodiment of the present application.

FIG. 2 is a connection diagram of a frying basket and a handle according to an embodiment of the present application.

FIG. 3 is a structural diagram of a frying basket according to an embodiment of the present application.

FIG. 4 is a structure diagram of a handle according to an embodiment of the present application.

The realization of the purpose, functional features and advantages of the present application will be further explained in conjunction with embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments of the present application, all other embodiments obtained by persons skilled in the art without creative efforts are within the scope of the present application.

It should be noted that all directional indications (such as up, down, left, right, front, back . . .) in the embodiments of the present application are only used to explain the relative position relationship, movement status, etc. between the various components under a certain specific posture (as shown in the accompanying drawings). If the specific posture changes, the directional indication will also change accordingly.

In addition, if there are descriptions involving “first”, “second”, etc. in the embodiments of the present application, the descriptions of “first”, “second”, etc. are only used for descriptive purposes and cannot be understood as indicating or implying their relative importance or implicitly indicating the number of technical features indicated. Therefore, the features defined as “first” and “second” may explicitly or implicitly include at least one of the features. In addition, if “and/or” appears in the full text, its meaning includes three parallel solutions. Taking “A and/or B” as an example, it includes solution A, solution B, or a solution that satisfies both A and B.

In addition, the technical solutions between the various embodiments of the present application can be combined with each other, but it must be based on the fact that persons skilled in the art can implement it. When the combination of technical solutions is contradictory or cannot be implemented, it should be deemed that such combination of technical solutions does not exist and is not within the scope of the present application.

Cooking equipment mainly consists of a furnace body and a deep fryer. The furnace body plays the role of supporting, protecting and providing heat source, while the deep fryer is used to hold oil and fry food. However, in the actual production process, researchers found that the traditional deep fryer needs to match the size of the furnace body before it can be placed in the furnace body for use. If the size of the deep fryer placed in the furnace body is too small, the deep fryer cannot be fixed. During the frying process, the deep fryer is very likely to shake, causing oil splashing and endangering the safety of the user. In other words, the traditional deep fryer can only be adapted to a single furnace body, and has technical problems such as poor compatibility and a small range of use.

The present application provides a deep fryer and a cooking equipment, aiming to solve the technical problem of poor compatibility of the deep fryer.

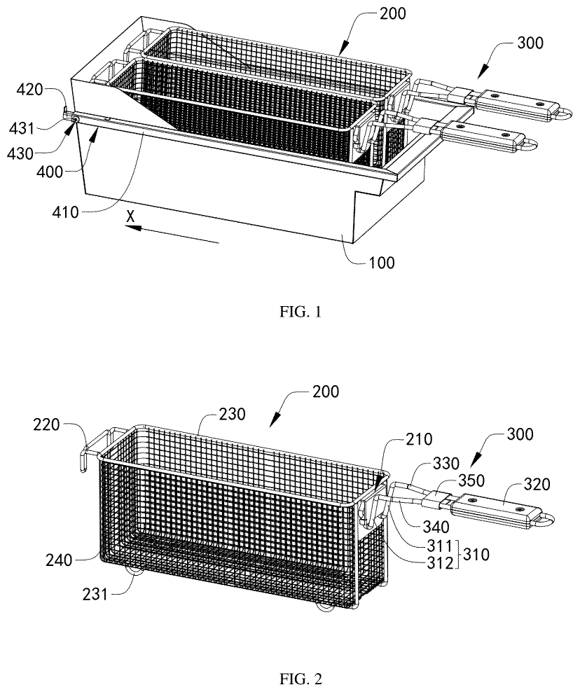

The deep fryer in the embodiment of the present application is applied to a cooking equipment, and the cooking equipment includes a furnace body. As shown in FIG. 1 and FIG. 2, in an embodiment of the present application, the deep fryer includes a pot body 100, a frying basket 200, a handle 300 and an adjustment assembly 400. The pot body 100 is provided in the furnace body, the frying basket 200 is provided in the pot body 100, and the handle 300 is detachably connected to the frying basket 200. The adjustment assembly 400 includes a slide rail 410, a slide rod 420 and a locking member 430. The slide rail 410 is provided at the outer wall surface of the pot body 100, the slide rod 420 is slidably provided at the slide rail 410 along a first direction and is used to abut against the inner wall of the furnace body, and the locking member 430 is provided at the slide rail 410 and is used to lock the position of the slide rod 420. The first direction refers to the direction indicated by X in FIG. 1, and in a specific embodiment, the first direction may be the front-back direction of the cooking equipment.

The technical solution of the present application can improve the compatibility of the fryer by arranging the adjustment assembly 400 including the slide rail 410, the slide rod 420 and the locking member 430 on the pot body 100, so that the deep fryer can be placed in a variety of furnace bodies of different sizes and fixed. In this embodiment, the pot body 100 is used to hold oil, the frying basket 200 is used to hold food, and the handle 300 can be held by the user so that the user can place the frying basket 200 in the pot body 100. The adjustment assembly 400 includes the slide rail 410, the slide rod 420 and the locking member 430. The slide rail 410 is installed on the outer wall surface of the pot body 100, and the slide rod 420 is slidably installed on the slide rail 410 and can abut against the inner wall of the furnace body to fix the position of the pot body 100. The locking member 430 is used to lock the position of the slide rod 420 to ensure that the position of the slide rod 420 is stable, thereby fixing the pot body 100 and ensuring that the position of the pot body 100 is stable when it is placed in the furnace body. The adjustment assembly 400 can improve the compatibility of the deep fryer, so that the deep fryer can be placed in a variety of furnace bodies of different sizes and fixed. Specifically, when the deep fryer is placed in furnace bodies of different sizes, the user can adjust the extension length of the slide rod 420 so that the slide rod 420 abuts against the inner wall of the furnace body, and use the locking member 430 to lock the position of the slide rod 420, so that the deep fryer can be firmly fixed in the furnace body, ensuring that the position of the deep fryer is stable when placed in furnace bodies of different sizes. In addition, the handle 300 of the deep fryer is detachably connected to the frying basket 200, which allows the user to remove the handle 300 from the frying basket 200 when frying food, and cover the furnace cover to fry food, so as to prevent oil from splashing outside the furnace body and endangering the safety of the user. The deep fryer is applied to the technical field of food processing equipment.

It should be noted that when the user puts the frying basket 200 into the pot body 100 to fry food through the handle 300, the handle 300 will be placed on the furnace body and extend out of the furnace body, which will cause the furnace cover to be unable to be completely covered. However, the deep fryer is designed to have a detachable structure for the handle 300 and the frying basket 200, so that the handle 300 can be removed when frying food. Without the restriction of the handle 300, the furnace cover of the cooking equipment can completely cover the furnace body to prevent oil from splashing outside the furnace body.

As shown in FIG. 1, in an embodiment of the present application, the slide rail 410 extends along a first direction, the slide rail 410 is provided with a guide hole extending along the first direction, and the slide rod 420 is slidably inserted into the guide hole. In this embodiment, by providing a guide hole on the slide rail 410 and sliding the slide rod 420 into the guide hole, it can provide a guide for the sliding of the slide rod 420 to ensure the stability of the slide rod 420 when sliding along the first direction. In a specific embodiment, the slide rail 410 can be a hollow rod.

As shown in FIG. 1, in another embodiment of the present application, the locking member 430 includes a locking block 431. The slide rod 420 is provided with a plurality of locking holes at intervals along the first direction. The locking block 431 can pass through the slide rail 410 and be inserted into any one of the locking holes to lock the position of the slide rod 420. In this embodiment, when the slide rod 420 slides to abut against the inner wall of the furnace body, the locking block 431 is passed through the slide rail 410 and inserted into the corresponding locking hole, so that the position of the slide rod 420 can be locked, thereby fixing the pot body 100 and ensuring the stability of the position of the pot body 100 when placed in the furnace body. In actual production and manufacturing, the plurality of locking holes on the slide rod 420 can be designed to have different spacing distances according to actual needs, and in order to facilitate the locking block 431 to pass through the slide rail 410, a plurality of through holes at intervals along the first direction can be opened on the slide rail 410.

In another embodiment of the present application, the locking member 430 includes a locking screw, and the locking screw can pass through the slide rail 410 and abut against the slide rod 420 to lock the position of the slide rod 420. In this embodiment, when the slide rod 420 slides to abut against the inner wall of the furnace body, the locking screw is passed through the slide rail 410 and abuts against the slide rod 420, so that the position of the slide rod 420 can be locked, thereby fixing the pot body 100 and ensuring that the position of the pot body 100 is stable when placed in the furnace body. In a specific embodiment, in order to facilitate the user to turn the locking screw, a grip plate can be provided at the end of the locking screw that does not pass through the slide rail 410, so that the user can grasp and turn the locking screw.

In order to reduce the length of the slide rod 420 and reduce the manufacturing cost of the deep fryer, a locking screw or a locking block 431 can be set at the end of the slide rod 420 that slides out of the slide rail 410. In the embodiment of the present application, a step portion is provided at an end of the pot body 100, and the slide rod 420 extends out of the guide hole from the end of the slide rod 420 away from the step portion. Specifically, one end of the pot body 100 is positioned and fixed by the step portion, and the other end of the pot body 100 is positioned and fixed by the slide rod 420.

As shown in FIG. 2, in an embodiment of the present application, a clamping block 210 is provided at the outer wall of the frying basket 200. The handle 300 includes a clamping portion 310, and the clamping portion 310 is clamped with the clamping block 210. In this embodiment, the frying basket 200 and the handle 300 are detachably connected by the clamping portion 310 cooperating with the clamping block 210, which can reduce the difficulty of disassembling the handle 300.

As shown in FIG. 2 to FIG. 4, in an embodiment of the present application, the clamping block 210 is provided with an accommodation cavity, an opening 211 and two clamping holes 212 arranged opposite to each other. The opening 211 is communicated with the accommodation cavity. The two clamping holes 212 are both communicated with the accommodation cavity and are adjacent to the opening 211. The clamping portion 310 includes a first clamping rod 311 and a second clamping rod 312 arranged at intervals, the first clamping rod 311 is provided with a first clamp 3111, and the second clamping rod 312 is provided with a second clamp 3121. The first clamping rod 311 and the second clamping rod 312 both pass through the opening 211 and are accommodated in the accommodation cavity, and the first clamp 3111 and the second clamp 3121 are respectively inserted into the two clamping holes 212. When installing the handle 300, the user only needs to squeeze the first clamping rod 311 and the second clamping rod 312 to reduce the distance between the first clamping rod 311 and the second clamping rod 312, so that the first clamping rod 311 and the second clamping rod 312 can pass through the opening 211 and be accommodated in the accommodation cavity. Then, under the action of the rebound force of the clamping rod, the first clamp 3111 and the second clamp 3121 will be inserted into the corresponding clamping hole 212, and the connection between the handle 300 and the frying basket 200 is completed. When disassembling the handle 300, the user only needs to squeeze the first clamping rod 311 and the second clamping rod 312 to reduce the distance between the first clamping rod 311 and the second clamping rod 312, so that the first clamp 3111 and the second clamp 3121 can be separated from the corresponding clamping hole 212, and then the first clamping rod 311 and the second clamping rod 312 can be pulled out of the accommodation cavity to complete the disassembly of the handle 300. The disassembly and assembly process of the handle 300 is simple and convenient, which can reduce the difficulty of disassembling the handle 300 for the user.

As shown in FIG. 4, in an embodiment of the present application, the first clamp 3111 is a first bent latch rod 3112, and the first bent latch rod 3112 is bent from the first clamping rod 311 to a direction away from the second clamping rod 312. The second clamp 3121 is a second bent latch rod 3122, and the second bent latch rod 3122 is bent from the second clamping rod 312 to a direction away from the first clamping rod 311. In this embodiment, the first clamp 3111 is formed by bending the first clamping rod 311, and the second clamp 3121 is formed by bending the second clamping rod 312, which can reduce the manufacturing difficulty of the handle 300 and the manufacturing difficulty of the deep fryer. In addition, the clamp formed by bending is an integrated structure with the clamping rod, which can increase the structural strength of the handle 300, does not require additional welding and other operations, and can reduce the manufacturing difficulty of the handle 300.

As shown in FIG. 4, in an embodiment of the present application, the handle 300 further includes a grip block 320, a first link rod 330, a second link rod 340 and a locking ring 350. The first link rod 330 and the second link rod 340 are provided apart from each other on the grip block 320. The first link rod 330 is connected to the first clamping rod 311, and the second link rod 340 is connected to the second clamping rod 312. The locking ring 350 is slidably sleeved on the first link rod 330 and the second link rod 340. The distance between the first link rod 330 and the second link rod 340 gradually decreases along the direction from the frying basket 200 to the handle 300. The locking ring 350 can slide to the end of the first link rod 330 and the second link rod 340 away from the grip block 320 to make the first link rod 330 and the second link rod 340 close to each other. When the user needs to disassemble the handle 300, the user only needs to push the lock ring 350 to the end of the first link rod 330 and the second link rod 340 away from the grip block 320, so as to reduce the distance between the first clamping rod 311 and the second clamping rod 312. When disassembling the handle 300, the user does not need to continuously squeeze the first clamping rod 311 and the second clamping rod 312, which can reduce the difficulty of disassembling the handle 300. In this embodiment, the first clamping rod 311, the first link rod 330, the second link rod 340 and the second clamping rod 312 are formed by bending a straight rod.

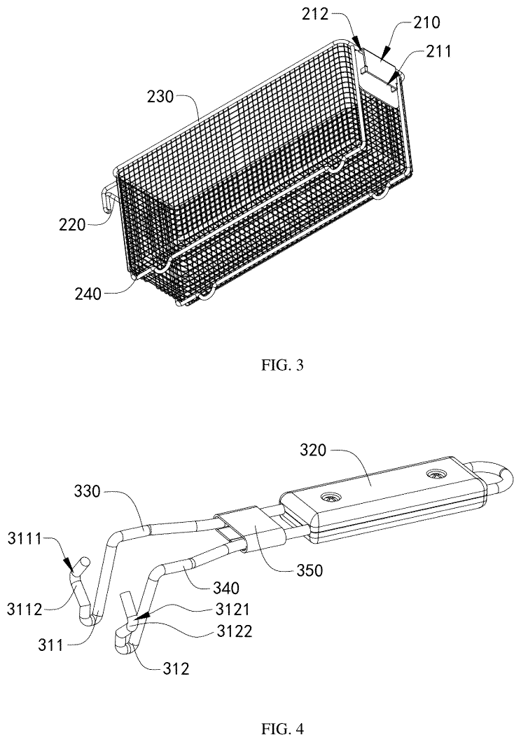

As shown in FIG. 3, in an embodiment of the present application, a hook 220 is provided at the end of the frying basket 200 away from the handle 300. The furnace body is provided with a hanger. The hook 220 can be hung on the hanger or the side plate of the pot body 100. After frying, the user can hang the frying basket 200 on the hanger of the furnace body or the side plate of the pot body 100 through the hook 220 to filter the oil and recover the oil remaining in the frying basket 200 or on the food.

In this embodiment, the frying basket 200 includes a frame 230 and a filter 240. The filter 240 is provided at the frame 230. A plurality of bent support rods 231 are disposed at the bottom of the frame 230, and each bent support rod 231 protrudes from the bottom of the frame 230 toward a direction away from the top of the frame 230. In this embodiment, the bent support rods 231 can support the frying basket 200 when the frying basket 200 is placed in the pot body 100, thereby reducing the contact area between the frying basket 200 and the bottom surface of the pot body 100.

The present application also proposes a cooking equipment, which includes the above-mentioned deep fryer. The specific structure of the deep fryer refers to the above-mentioned embodiments. Since the cooking equipment adopts all the technical solutions of all the above-mentioned embodiments, it at least has all the beneficial effects brought by the technical solutions of the above-mentioned embodiments, which will not be repeated here. Specifically, the cooking equipment includes a furnace body and two of the above-mentioned deep fryers, and a heating unit is arranged in the furnace body. The two deep fryers are arranged in the furnace body at intervals and are both located above the heating unit. The heating unit, as a heat source, can provide heat to heat the deep fryer. In a specific embodiment, the heating unit can be a combustible material such as coal, charcoal, and particles, or a heating component with a heating function (such as a heating tube, etc.).

The above description is only an exemplary embodiment of the present application, and does not limit the patent scope of the present application. All equivalent structural changes made by using the contents of the present application specification and drawings under the technical concept of the present application, or directly/indirectly applied in other related technical fields are included in the scope of the present application.

What is claimed is:

1. A deep fryer, applied to a cooking equipment comprising a furnace body, comprising:
a pot body provided in the furnace body;
a frying basket provided in the pot body;
a handle detachably connected to the frying basket; and
an adjustment assembly comprising a slide rail, a slide rod and a locking member;
wherein the slide rail is provided at an outer wall surface of the pot body; the slide rod is slidably provided at the slide rail along a first direction and is configured to abut against an inner wall of the furnace body, and the locking member is provided at the slide rail and is configured to lock a position of the slide rod.

2. The deep fryer according to claim 1, wherein the slide rail is configured to extend along the first direction; the slide rail is provided with a guide hole extending along the first direction, and the slide rod is slidably provided in the guide hole.

3. The deep fryer according to claim 2, wherein the locking member comprises a locking screw, and the locking screw is configured to pass through the slide rail and abut against the slide rod to lock the position of the slide rod.

4. The deep fryer according to claim 2, wherein the locking member comprises a locking block, and the slide rod is provided with a plurality of locking holes spaced apart along the first direction; and the locking block is configured to pass through the slide rail and is inserted into any one of the locking holes to lock the position of the slide rod.

5. The deep fryer according to claim 1, wherein a clamping block is provided at an outer wall surface of the frying basket; the handle comprises a clamping portion, and the clamping portion is clamped with the clamping block.

6. The deep fryer according to claim 5, wherein
the clamping block is provided with an accommodation cavity, an opening and two clamping holes provided opposite to each other, and the opening is communicated with the accommodation cavity;
the two clamping holes are both communicated with the accommodation cavity and are adjacent to the opening;
the clamping portion comprises a first clamping rod and a second clamping rod provided at an interval; the first clamping rod is provided with a first clamp, and the second clamping rod is provided with a second clamp; and
the first clamping rod and the second clamping rod are configured to pass through the opening and are accommodated in the accommodation cavity; the first clamp is inserted into one clamping hole, and the second clamp is inserted into the other clamping hole.

7. The deep fryer according to claim 6, wherein the first clamp is a first bent latch rod, and the first bent latch rod is bent from the first clamping rod to a direction away from the second clamping rod; and the second clamp is a second bent latch rod, and the second bent latch rod is bent from the second clamping rod to a direction away from the first clamping rod.

8. The deep fryer according to claim 7, wherein
the handle further comprises a grip block, a first link rod, a second link rod and a locking ring;
the first link rod and the second link rod are provided apart at the grip block; the first link rod is connected to the first clamping rod, and the second link rod is connected to the second clamping rod;
the locking ring is slidably provided at the first link rod and the second link rod, and a distance between the first link rod and the second link rod gradually decreases along a direction from the frying basket to the handle; and
the locking ring is configured to slide to an end of the first link rod and the second link rod away from the grip block to make the first link rod and the second link rod close to each other.

9. The deep fryer according to claim 1, wherein a hook is provided at an end of the frying basket away from the handle; the furnace body is provided with a hanger, and the hook is hung on the hanger or a side plate of the pot body.

10. A cooking equipment, comprising:
a furnace body provided with a heating unit; and
two deep fryers according to claim 1, provided in the furnace body at an interval and provided above the heating unit.
